(19) United States
(12) Patent Application Publication
(10) Pub. No.: US 2007/0073930 A1
(43) Pub. Date: Mar. 29, 2007

(54) Multipurpose video integrated switch

(75) Inventors: Pao-Ta Yu, Banciao City (TW); Yuan-Hau Chung, Banciao City (TW)

Correspondence Address: TROXELL LAW OFFICE PLLC, SUITE 1404, 5205 LEESBURG PIKE, FALLS CHURCH, VA, 22041, US

(73) Assignee: Pao-Ta Yu

(21) Appl. No.: 11/373,960

(22) Filed: Mar. 14, 2006

(30) Foreign Application Priority Data
Sep. 5, 2005 (TW) 094215259

(51) Int. Cl. G06F 3/00

(52) U.S. Cl. 710/51

(57) ABSTRACT

A multipurpose video integrated switch is a design related to a distributor and a sharer for computer video signals. The integrated switch includes a power switch, a plurality of input ports, and a plurality of output ports, and its interior is installed with a control unit connected to the power switch, input ports, and output ports. The control unit is composed of a control circuit, a power circuit, a change-over circuit, a plurality of multiplexer circuits, and a plurality of balanced circuits. Accordingly, multiple video signals can be input simultaneously and transmitted to a plurality of displayers respectively, for achieving a function of video distribution and sharing.

### BACKGROUND OF THE INVENTION

(a) Field of the Invention The present invention, a multipurpose video integrated switch, refers to a design related to a distributor and a sharer for computer video signals, and more particularly to a multipurpose video integrated switch which can be input with multiple video signals and transmitted to a plurality of displayers respectively after processing the input video signals, to achieve functions of video distribution and sharing.

(b) Description of the Prior Art

It is well known that video equipment is gradually becoming a main stream in the market, which can achieve an effect of integrating the video signals through the video equipment, such as a monitoring system, and a video distributor, etc., are largely applied in a rim of life.

Video box hardware in the current market include a video switch (or a screen sharer) and a video sharer. The so-called video switch (or screen sharer) is primarily applied in a computer room control of a monitoring system or in a sharing of an output device by a plurality of computers. On the other hand, the video sharer is primarily used in a showground or a repeated display of images, that is, signals in one computer being duplicated to a plurality of screens.

As the application of the aforementioned devices is more specific, if a plurality of computers needs to be used at the same time to optionally output to a plurality of output devices, for example, an episcope and a computer are operated at the same time in more and more teaching conditions, the video switch (or screen sharer) and the video distributor should be connected in cascade, which will require more cabling, and thus causing an inconvenience in application.

### SUMMARY OF THE INVENTION

Accordingly, the primary object of present invention is to provide a multipurpose video integrated switch which integrates a video switch and a video distributor into a single unit and includes a power switch, a plurality of input ports, and a plurality of output ports. An interior of the multipurpose video integrated switch is provided with a control unit which is connected to the power switch, input ports, and output ports, and the control unit includes a control circuit, a power circuit, a change-over circuit, a plurality of multiplexer circuits, and a plurality of balanced circuits, so as to input multiple video signals simultaneously and dispatch to multiple displayers, thereby achieving the functions of video distribution and sharing.

Another object of the present invention is to provide a multipurpose video integrated switch which is further provided with a function button connected with the internal control unit, for selecting the required scenario of distribution and sharing through the function button, in order to facilitate an operator to choose the best scenario for distributing.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a first direction of the present invention.

FIG. 2 shows a schematic view of a second direction of the present invention.

FIG. 3 shows a schematic view of a circuit of control unit of the present invention.

FIG. 4 shows a schematic view of the present invention as a switch.

FIG. 5 shows a schematic view of the present invention as a sharer.

### DETAILED DESCRIPTION OF THE PREFERRED EMBODIMENTS

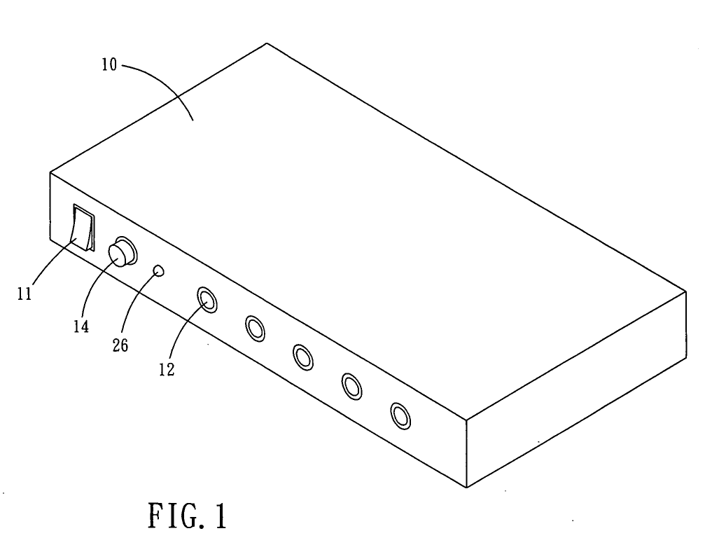

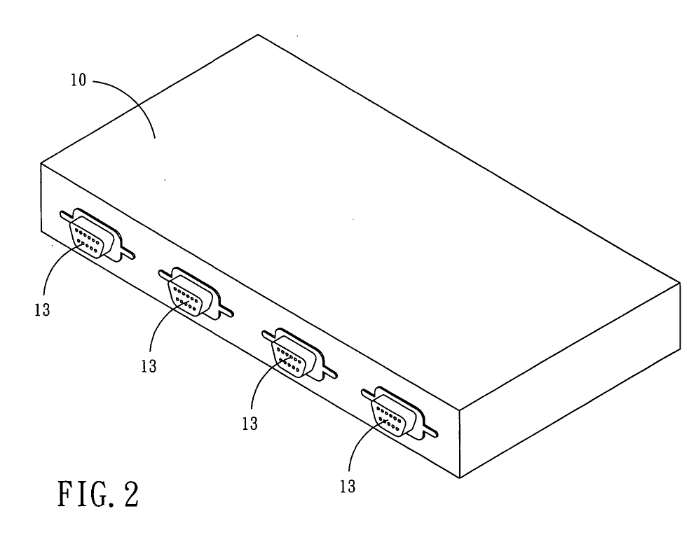

Referring to FIG. 1 and FIG. 2, an integrated switch 10 integrates a video switch and a video distributor into a single unit, and is provided with a power switch 11, a plurality of input ports 12, and a plurality of output ports 13.

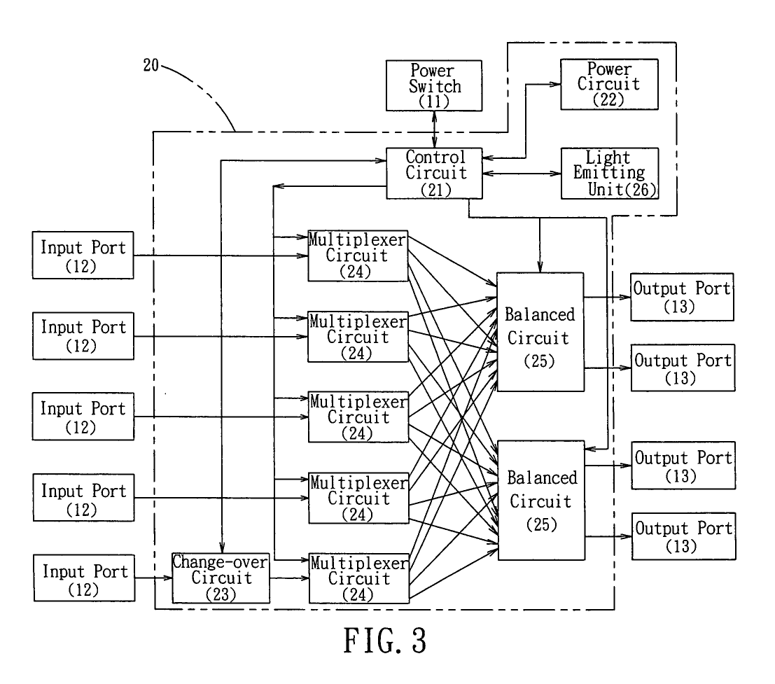

Referring to FIG. 3, an interior of the integrated switch 10 is installed with a control unit 20 which is connected with the power switch 11, input ports 12, and output ports 13, respectively. The control unit 20 includes further a control circuit 21, a power circuit 22, a change-over circuit 23, a plurality of multiplexer circuits 24, and a plurality of balanced circuits 25.

The power switch 11 and power circuit 22 are directly connected to the control circuit 21 to activate the power circuit 21 for providing power required in driving the control circuit 21, through a switching of the power switch 11. On the other hand, the change-over circuit 21, multiplexer circuits 24, and balanced circuits 25 are connected to the control circuit 21 respectively, and the input ports 12 and change-over circuit 23 are connected to the multiplexer circuits 24; whereas the output ports 13 are connected to the balanced circuits 25.

The change-over circuit 23 is connected between the input ports 12 and the multiplexer circuits 24 to primarily convert S-Video signals into RGB (Red-Green-Blue) signals. Therefore, when the S-Video signals are received by the input ports 12, they are converted into the RGB signals through the change-over circuit 23, and then transmitted to the multiplexer circuits 24.

Accordingly, when signals are received by the input ports 12, they can be simultaneously transmitted to the plurality of balanced circuits 25 through the multiplexer circuits 24 in the control unit 20, and then transmitted to the output ports 13 through each balanced circuit 24 respectively, so as to be transmitted out through the output ports 13.

Referring to the drawings, the control circuit 21 can be further installed with a light emitting unit 26 which is protruded at an exterior of the integrated switch 10. The light emitting unit 26 in the present embodient is an LED (Light Emitting Diode). Therefore, when power is activated by the power switch 26, the light emitting unit 26 can be driven to emit light through the control circuit 21, thereby informing an operator that the integrated switch 10 has been activated. In addition, the integrated switch 10 can be further installed with a function button 14 which is connected to the internal control unit 20, to select a required scenario of distribution or sharing through the function button 14, thereby facilitating the operator to select a best scenario for distributing. Of course the function button 14 can also be operated remotely.

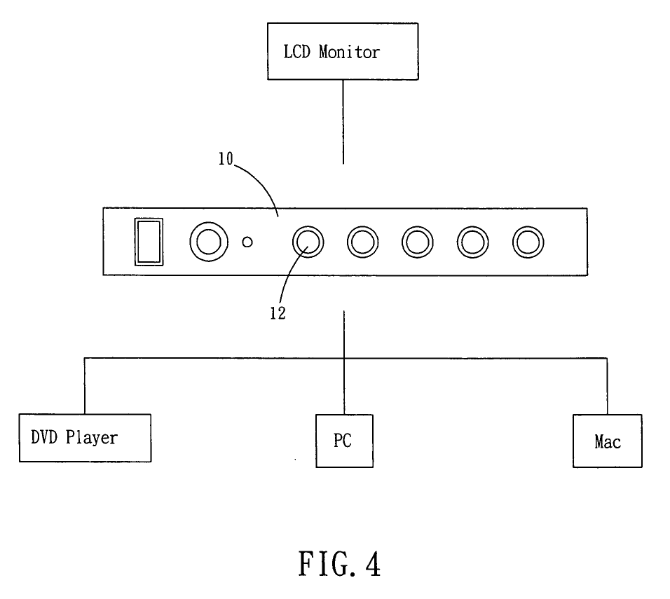

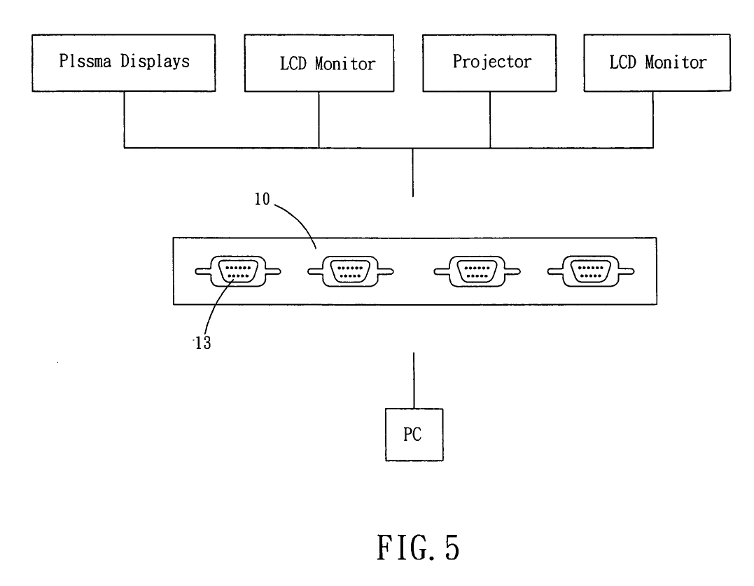

Referring to FIG. 4 and FIG. 5, when the integrated switch 10 is used as a switch, the input ports 12 on the integrated switch 10 are primarily connected to a DVD (Digital Video Disc) player, a PC (Personal Computer), and a Mac (Macintosh), and the output ports 13 are installed with LCD (Liquid Crystal Display) monitors. On the other hand, when the integrated switch 10 is used as a distributor, the input ports 12 are connected to PCs, and the output ports 13 are connected to a plasma display, an LCD monitor, and a projector.

Accordingly, the integrated switch 10 of present invention can be used to receive multiple signals, be applied to various kinds of input and output devices, and be used for multiple purposes in, such as a far distance application (30-65 m, embedded with an enhanced function of video signals, such as a public display system, a large-scaled showground, an auditorium, and a performance hall), an intermediate distance application (10-30 m, such as a mid-sized showground, a restaurant, a performance hall, an auditorium, an outdoor activity, and a large-scaled classroom), and a near distance application (less than 10 m, such as an auditorium, small-scaled showground, and a classroom), for public information displays, conferences, exhibitions, live activities, and teachings.

Furthermore, the function button 14 on the integrated switch 10 can be further provided with following three modes:
1. The parallel mode wherein a single input device is corresponding to a single output device.
2. The mirror mode wherein a single input device is corresponding to a plurality of output devices.
3. The live mode wherein a plurality of input devices in corresponding to a plurality of output devices, which are used primarily for a live broadcasting and a transmission of contrast data.

In addition, when the integrated switch 10 is used as a switch, it can achieve a function of 1 to 1, 2 to 1, 3 to 1, and 4 to 1; and when it is used as a sharer, it can achieve a function of 1 to 2, 1 to 3, and 1 to 4; whereas when it is used as a multiple-purpose sharer, it can achieve a function of 2 to 3, 3 to 3, 4 to 3, and 4 to 4.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multipurpose video integrated switch integrating a video switch and a video distributor into a single unit, which is provided with a power switch, a plurality of input ports, and a plurality of output ports, and an interior of which is installed with a control unit connected to the power switch, input ports, and output ports, respectively; the control unit further including a control circuit, a power circuit, a change-over circuit, a plurality of multiplexer circuits, and a plurality of balanced circuits; the power switch and power circuit being directly connected to the control circuit to activate the power circuit through a switching of power switch, for providing power required to drive the control circuit; the change-over circuit, multiplexer circuits, and balanced circuits being connected to the control circuit respectively, the input ports and change-over circuit being connected to the multiplexer circuits, the output ports being connected to the balanced circuits, and the change-over circuit being connected between the input ports and multiplexer circuits.

2. The multipurpose video integrated switch according to claim 1, wherein the control circuit is further installed with at least one light emitting unit protruded at an exterior of the integrated switch.

3. The multipurpose video integrated switch according to claim 2, wherein the light emitting unit is an LED.

4. The multipurpose video integrated switch according to claim 1, wherein the integrated switch is further provided with a function button which is connected to the control unit, in order to choose a required scenario of distribution or sharing through the function button.

5. The multipurpose video integrated switch according to claim 1, wherein the input ports are connected to a DVD player, a PC, and a Mac.

6. The multipurpose video integrated switch according to claim 1, wherein the output ports are connected to a plasma display, an LCD monitor, and a projector.

7. The multipurpose video integrated switch according to claim 4, wherein the function button can be synchronously operated with a remote controller.
